(19) United States
(12) Patent Application Publication
(10) Pub. No.: US 2021/0027215 A1
(43) Pub. Date: Jan. 28, 2021

(54) COORDINATING GROUP TRAVEL PLANS

(71) Applicant: INTERNATIONAL BUSINESS MACHINES CORPORATION, Armonk, NY (US)

(72) Inventors: Adaoha ONYEKWELU, Wappingers Falls, NY (US); Ali Y. DUALE, Poughkeepsie, NY (US); Abuchi OBIEGBU, Poughkeepsie, NY (US); Ronald Asomah DARTEY, Poughkeepsie, NY (US); Jeffrey NETTEY, Pleasant Valley, NY (US)

(21) Appl. No.: 16/517,804

(22) Filed: Jul. 22, 2019

(51) Int. Cl. G06Q 10/02; G06Q 50/12

(52) U.S. Cl. CPC G06Q 10/025; G06Q 50/12

(57) ABSTRACT

A computer-implemented method for group travel coordination. Aspects include receiving a travel itinerary from a first user and storing the travel itinerary and an identification of a group of individuals that the first user has elected to share the travel itinerary with. Aspects also include monitoring a travel booking activity of the group of individuals. Based on a determination that a member of the group of individuals is booking a trip that is related to the travel itinerary, aspects include providing an itinerary recommendation to the member of the group of individuals.

### BACKGROUND

The present invention generally relates to a travel coordination system, and more specifically, to a system for coordinating travel plans among a group of individuals.

Often a group of individuals tries to coordinate their travel plans such that they can spend time together. However, when it comes to coordinating schedules and travel, it is difficult to keep up with friends and family. Currently, some individuals use social media outlets to see where their connections are traveling to, and this comes into play when making vacation plans.

### SUMMARY

Embodiments of the present invention are directed to a computer-implemented method for group travel coordination. A non-limiting example of the computer-implemented method includes receiving a travel itinerary from a first user. The method also includes storing the travel itinerary and an identification of a group of individuals that the first user has elected to share the travel itinerary with. The method further includes monitoring a travel booking activity of the group of individuals. Based on a determination that a member of the group of individuals is booking a trip that is related to the travel itinerary, the method also includes providing an itinerary recommendation to the member of the group of individuals.

Embodiments of the present invention are directed to a system for group travel coordination. A non-limiting example of the system includes a processor in communication with one or more types of memory. The processor is configured to receive a travel itinerary from a first user and store the travel itinerary and an identification of a group of individuals that the first user has elected to share the travel itinerary with. The processor is configured to monitor a travel booking activity of the group of individuals. Based on a determination that a member of the group of individuals is booking a trip that is related to the travel itinerary, the processor is configured to provide an itinerary recommendation to the member of the group of individuals.

Embodiments of the invention are directed to a computer program product for group travel coordination the computer program product comprising a computer readable storage medium having program instructions embodied therewith. The program instructions are executable by a processor to cause the processor to perform a method. A non-limiting example of the method includes receiving a travel itinerary from a first user and storing the travel itinerary and an identification of a group of individuals that the first user has elected to share the travel itinerary with. The method further includes monitoring a travel booking activity of the group of individuals. Based on a determination that a member of the group of individuals is booking a trip that is related to the travel itinerary, the method also includes providing an itinerary recommendation to the member of the group of individuals.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to an embodiment of the present invention;

FIG. 2 depicts abstraction model layers according to an embodiment of the present invention;

FIG. 3 depicts a high-level block diagram computer system, which can be used to implement one or more aspects of the present invention;

FIG. 4 depicts a flowchart of a method for group travel coordination according to an embodiment of the invention; and

FIG. 5 depicts a flowchart of another method for group travel coordination according to an embodiment of the invention.

The diagrams depicted herein are illustrative. There can be many variations to the diagrams or the operations described therein without departing from the spirit of the invention. For instance, the actions can be performed in a differing order or actions can be added, deleted or modified. Also, the term “coupled” and variations thereof describe having a communications path between two elements and do not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

### Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems; storage, deployed applications, and possibly limited control of select networking components (e.g., host firewalls).

### Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

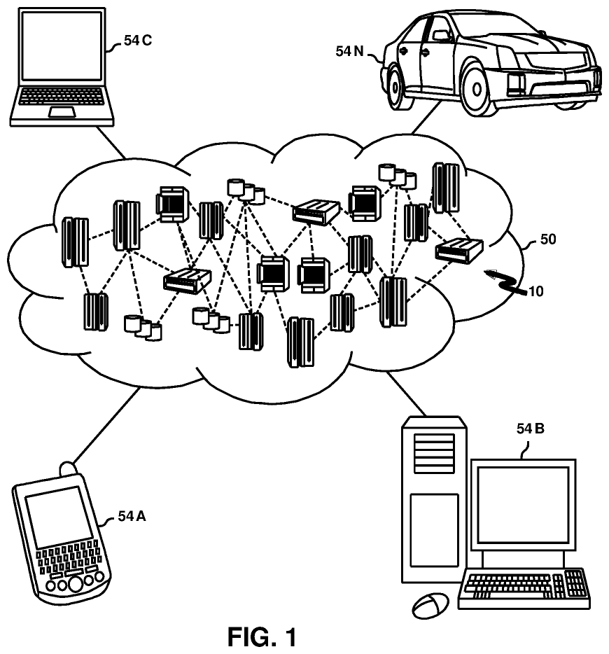

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

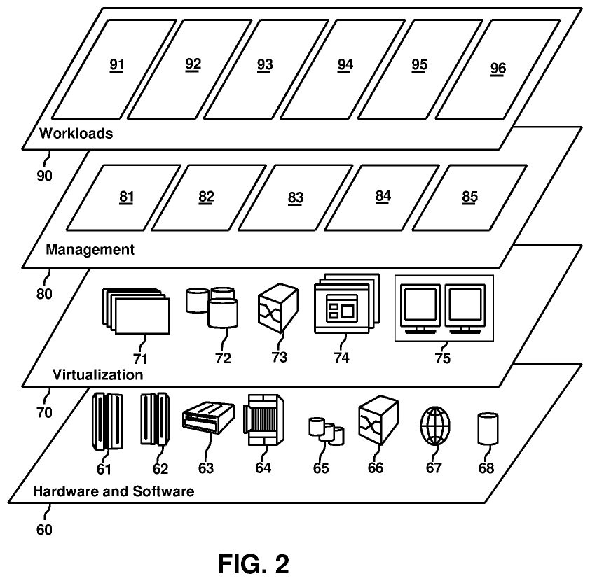

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85, provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; anomalies process 95; and group travel coordination 96.

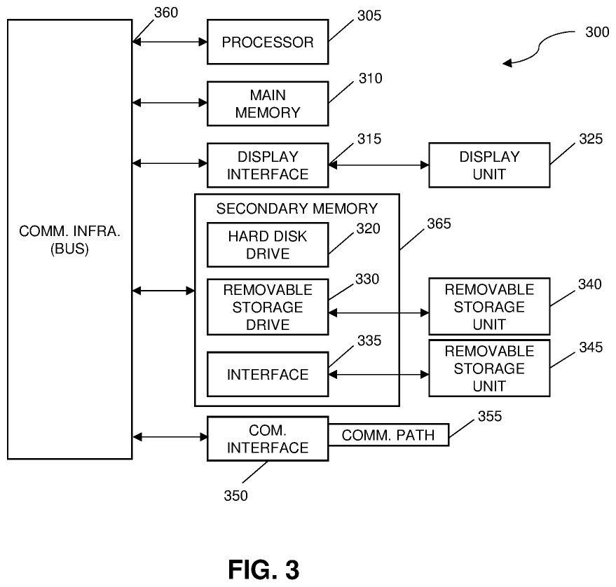

FIG. 3 depicts a high-level block diagram computer system 300, which can be used to implement one or more aspects of the present invention. More specifically, computer system 300 can be used to implement some hardware components of embodiments of the present invention. Although one exemplary computer system 300 is shown, computer system 300 includes a communication path 355, which connects computer system 300 to additional systems (not depicted) and can include one or more wide area networks (WANs) and/or local area networks (LANs) such as the Internet, intranet(s), and/or wireless communication network(s). Computer system 300 and additional system are in communication via communication path 355, e.g., to communicate data between them.

Computer system 300 includes one or more processors, such as processor 305. Processor 305 is connected to a communication infrastructure 360 (e.g., a communications bus, cross-over bar, or network). Computer system 300 can include a display interface 315 that forwards graphics, text, and other data from communication infrastructure 360 (or from a frame buffer not shown) for display on a display unit 325. Computer system 300 also includes a main memory 310, preferably random access memory (RAM), and can also include a secondary memory 365. Secondary memory 365 can include, for example, a hard disk drive 320 and/or a removable storage drive 330, representing, for example, a floppy disk drive, a magnetic tape drive, or an optical disk drive. Removable storage drive 330 reads from and/or writes to a removable storage unit 340 in a manner well known to those having ordinary skill in the art. Removable storage unit 340 represents, for example, a floppy disk, a compact disc, a magnetic tape, or an optical disk, etc. which is read by and written to by removable storage drive 330. As will be appreciated, removable storage unit 340 includes a computer readable medium having stored therein computer software and/or data.

In alternative embodiments, secondary memory 365 can include other similar means for allowing computer programs or other instructions to be loaded into the computer system. Such means can include, for example, a removable storage unit 345 and an interface 335. Examples of such means can include a program package and package interface (such as that found in video game devices), a removable memory chip (such as an EPROM, or PROM) and associated socket, and other removable storage units 345 and interfaces 335 which allow software and data to be transferred from the removable storage unit 345 to computer system 300.

Computer system 300 can also include a communications interface 350. Communications interface 350 allows software and data to be transferred between the computer system and external devices. Examples of communications interface 350 can include a modem, a network interface (such as an Ethernet card), a communications port, or a PCM-CIA slot and card, etcetera. Software and data transferred via communications interface 350 are in the form of signals which can be, for example, electronic, electromagnetic, optical, or other signals capable of being received by communications interface 350. These signals are provided to communications interface 350 via communication path (i.e., channel) 355. Communication path 355 carries signals and can be implemented using wire or cable, fiber optics, a phone line, a cellular phone link, an RF link, and/or other communications channels.

In the present description, the terms “computer program medium,” “computer usable medium,” and “computer readable medium” are used to generally refer to media such as main memory 310 and secondary memory 365, removable storage drive 330, and a hard disk installed in hard disk drive 320. Computer programs (also called computer control logic) are stored in main memory 310 and/or secondary memory 365. Computer programs can also be received via communications interface 350. Such computer programs, when run, enable the computer system to perform the features of the present invention as discussed herein. In particular, the computer programs, when run, enable processor 305 to perform the features of the computer system. Accordingly, such computer programs represent controllers of the computer system.

Turning now to an overview of technologies that are more specifically relevant to aspects of the invention, methods, systems and computer program products for group travel coordination are provided. In exemplary embodiments, a group travel coordination system allows a user to share their travel itinerary with a group of individuals such as their family, friends, and/or co-workers. In exemplary embodiments, when users book travel plans they provide an indication of which individuals, or groups, that they want to share their travel plans with. Subsequently, when other users are looking to book travel, they are presented with the travel trend of their contacts as well as recommendations that are based in part on the travel itinerary of their contacts that have booked related trips. In general, related trips are trips to the same destination within a threshold amount of time.

In exemplary embodiments, the group travel coordination system is configured to provide travel recommendations that maximize the amount of time the parties can spend together. For example, a first user is traveling and indicates that they are flexible (within certain dates) and authorizes a group of other individuals to see their reservations. Next, a second user, that is within the first user's group of other individuals is making a reservation. In one embodiment, the group travel coordination system notifies the second user that the first user is traveling to the same destination that the second person is booking travel to and the second user can then decide whether or not book the same details (flight, hotel, etc). In another embodiment, the group travel coordination system provides a recommendation, such as a suggested flight or hotel, based on the travel itinerary of the first user. In one embodiment, the group travel coordination system is configured to notify the first user of the booked travel plans of the second user such that the first user can make changes to their itinerary based on the booked travel plans of the second user.

In exemplary embodiments, the group travel coordination system is configured to track travel plans for groups of individuals and to identify trends in their travel plans. The group travel coordination system is also configured to share information relating to the travel plans of individuals with approved friends and family. In exemplary embodiments, the sharing of travel plans can be done directly or indirectly. In one embodiment, direct sharing is done by providing notifications to the permitted contacts. In another embodiment, the travel plans are shared indirectly by the creation of travel trends. The travel trends are created by aggregating data from the travel plans of individuals in a group. For example, the group travel coordination system accumulates each travel information of each user's contacts and builds a personalized information on the travel trend of one's contacts.

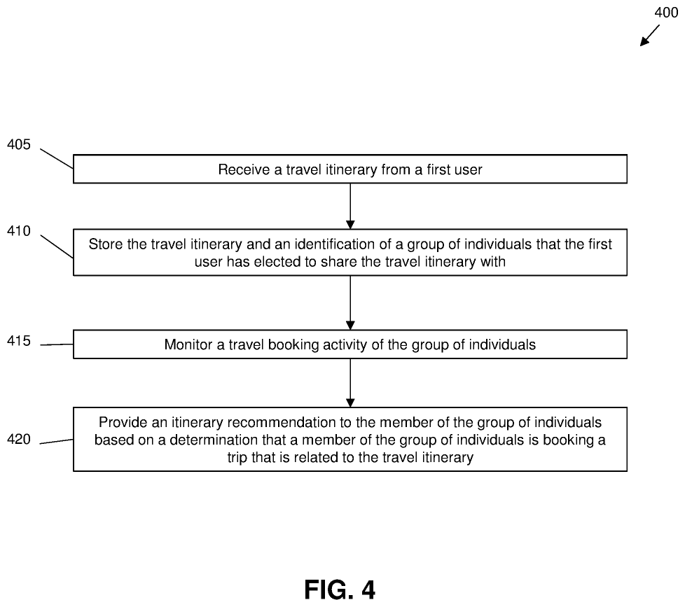

Referring now to FIG. 4 a flowchart of a method 400 for group travel coordination in accordance with an embodiment is shown. As shown at block 405, the method 400 includes receiving a travel itinerary from a first user. In exemplary embodiments, the travel itinerary includes a destination, travel dates, a hotel, and one or more events during the travel dates that the user will attend. In one embodiment, the one or more events during the travel dates that the user will attend indicate an availability of the first user during portions of a trip. For example, the events may indicate that the first user is going to be attending a sporting event or a conference while on their trip. Next, as shown at block 410, the method 400 includes storing the travel itinerary and an identification of a group of individuals that the first user has elected to share the travel itinerary with. In one embodiment, the identification of the group of individuals is obtained from a user profile of the first user. For example, the user profile may include multiple groups, such as friends, family, co-workers, and the like, and the user can select which group(s) to share their itinerary with at the time of booking. In another embodiment, the identification of the group of individuals is received from the first user. For example, the first user can include a selection of individuals to share their itinerary with at the time of booking.

Continuing with reference to FIG. 4, as shown at block 415, the method 400 includes monitoring a travel booking activity of the group of individuals. The method 400 also includes providing an itinerary recommendation to the member of the group of individuals based on a determination that a member of the group of individuals is booking a trip that is related to the travel itinerary, as shown at block 420. In exemplary embodiments, the determination that the trip is related to the travel itinerary is based upon the trip and the travel itinerary being trips to the same destination within a threshold time of one another. In exemplary embodiments, the itinerary recommendation includes a hotel recommendation and recommended dates of travel, where the recommended dates of travel are selected to maximize overlap with the travel itinerary of the first user.

In exemplary embodiments, one the member of the group of individuals books a trip, the first user is notified and provided a copy of their itinerary. As a result, the first user can elect to make changes to their itinerary to increase the amount of time that they will be able to spend with the member of the group of individuals. In exemplary embodiments, upon any user booking travel arrangements, the group travel coordination system is configured to provide a notification to the selected group of individuals of the travel itinerary. Such notifications can be sent upon a user booking an initial reservation, upon the user modifying the reservation, or upon another user booking a similar itinerary.

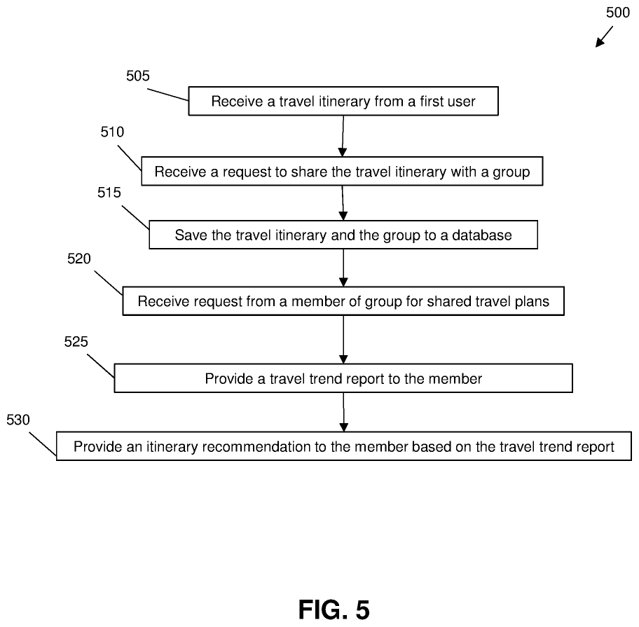

Referring now to FIG. 5 a flowchart of a method 500 for group travel coordination in accordance with an embodiment is shown. As shown at block 505, the method 500 includes receiving a travel itinerary from a first user. Next, as shown at block 510, the method 500 includes receiving a request to share the travel itinerary with a group. The method 500 also includes saving the travel itinerary and the group to a database. In one embodiment, the request to share the travel itinerary with a group includes an identification of the members of the group. In another embodiment, the request to share the travel itinerary with a group includes an identification of a previously created and stored group for the first user. For example, the first user previously created and stored various groups, such as a family group, a college friends group, a couple friends group, or the like.

Next, as shown at block 520, the method 500 includes receiving a request from a member of the group for shared travel plans. For example, a user can access the group travel coordination system and submit a request for shared travel plans. The request can include a specific time period, a specific destination, and/or a specific user, or the like. The method 500 also includes providing a travel trend report to the member, as shown at block 525. In exemplary embodiments, the travel trend report includes the travel itinerary from a first user and the travel itinerary of other members of the group. Next, as shown at block 530, the method 500 includes providing an itinerary recommendation to the member based on the travel trend report. In exemplary embodiments, the itinerary recommendation includes a hotel recommendation and recommended dates of travel, where the recommended dates of travel are selected to maximize overlap with the travel itinerary of the first user.

In exemplary embodiments, once the member of the group books travel arrangements, the itinerary of the member of the group is stored and the member is asked to identify any additional individuals that they want to share their itinerary with. The travel itinerary of the member of the group can also be sent to the first user to inform the first user of the travel plans of the member of the group.

In exemplary embodiments, the group travel coordination system is configured to automatically modify the travel arrangements of the first user based on the itinerary of another member of the group. For example, if the first user books a room at a first hotel and the other members of the group book at a second hotel due to a better price or lack of additional rooms at the first hotel, the group travel coordination system may automatically change the reservation from the first hotel to the second hotel.

In exemplary embodiments, the group travel coordination system is configured to monitor the trend of travel information before and after arrangements are made. In one embodiment, users are permitted to modify their itinerary based on updates on the travel arrangements of his/her contacts even after the booking is completed. For example, the group travel coordination system allows the user to change their itinerary based on booking information from friends/family members.

In exemplary embodiments, a cloud computing system such as the one shown in FIGS. 1-2 is used to perform the methods 400 and 500 shown in FIGS. 4 and 5. In other embodiments, a computer system 300 such as the one shown in FIG. 3 is used to perform the methods 400 and 500 shown in FIGS. 4 and 5.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for group travel coordination, the method comprising:
receiving a travel itinerary from a first user;
storing the travel itinerary and an identification of a group of individuals that the first user has elected to share the travel itinerary with;
monitoring a travel booking activity of the group of individuals; and
based on a determination that a member of the group of individuals is booking a trip that is related to the travel itinerary, providing an itinerary recommendation to the member of the group of individuals.

2. The computer-implemented method of claim 1, wherein the determination that the trip is related to the travel itinerary is based upon the trip and the travel itinerary being trips to a same destination within a threshold time of one another.

3. The computer-implemented method of claim 1, wherein the identification of the group of individuals is obtained from a user profile of the first user.

4. The computer-implemented method of claim 1, wherein the identification of the group of individuals is received from the first user.

5. The computer-implemented method of claim 1, wherein the itinerary recommendation includes a hotel recommendation.

6. The computer-implemented method of claim 1, wherein the itinerary recommendation includes recommended dates of travel.

7. The computer-implemented method of claim 1, wherein recommended dates of travel are selected to maximize an overlap with the travel itinerary of the first user.

8. The computer-implemented method of claim 1, further comprising:
receiving an itinerary for the member of the group of individuals; and
notifying the first user of the itinerary of the member of the group of individuals.

9. The computer-implemented method of claim 1, further comprising notifying the group of individuals of the travel itinerary of the first user.

10. The computer-implemented method of claim 1, wherein the travel itinerary of the first user includes a destination, travel dates, a hotel, and one or more events during the travel dates that the user will attend.

11. A computer program product for group travel coordination, the computer program product comprising:
a computer readable storage medium readable by a processing circuit and storing program instructions for execution by the processing circuit for performing a method comprising:
receiving a travel itinerary from a first user;
storing the travel itinerary and an identification of a group of individuals that the first user has elected to share the travel itinerary with;
monitoring a travel booking activity of the group of individuals; and
based on a determination that a member of the group of individuals is booking a trip that is related to the travel itinerary, providing an itinerary recommendation to the member of the group of individuals.

12. The computer program product of claim 11, wherein the determination that the trip is related to the travel itinerary is based upon the trip and the travel itinerary being trips to a same destination within a threshold time of one another.

13. The computer program product of claim 11, wherein the identification of the group of individuals is obtained from a user profile of the first user.

14. The computer program product of claim 11, wherein the identification of the group of individuals is received from the first user.

15. The computer program product of claim 11, wherein the itinerary recommendation includes a hotel recommendation.

16. The computer program product of claim 11, wherein the itinerary recommendation includes recommended dates of travel.

17. The computer program product of claim 11, wherein recommended dates of travel are selected to maximize an overlap with the travel itinerary of the first user.

18. The computer program product of claim 11, wherein the method further comprises:
receiving an itinerary for the member of the group of individuals; and
notifying the first user of the itinerary of the member of the group of individuals.

19. The computer program product of claim 11, wherein the method further comprises notifying the group of individuals of the travel itinerary of the first user.

20. A processing system for group travel coordination, the processor system comprising:
a processor in communication with one or more types of memory, the processor configured to:
receive a travel itinerary from a first user;
store the travel itinerary and an identification of a group of individuals that the first user has elected to share the travel itinerary with;
monitor a travel booking activity of the group of individuals; and
based on a determination that a member of the group of individuals is booking a trip that is related to the travel itinerary, provide an itinerary recommendation to the member of the group of individuals.
